(19) United States
(12) Patent Application Publication
(10) Pub. No.: US 2003/0177677 A1
(43) Pub. Date: Sep. 25, 2003

(54) Winter dome

(76) Inventor: Rodney J. Acosta SR., Marrero, LA (US)

Correspondence Address: RODNEY ACOSTA, 5236 KAREN DR., MARRERO, LA, 70072, US

(21) Appl. No.: 10/369,741

(22) Filed: Jan. 18, 2002

(51) Int. Cl. G09F 19/00; G09F 19/08

(52) U.S. Cl. 40/410; 40/414

(57) ABSTRACT

The Winter Dome uses air to circulate snow material from a base into a clear dome where it softly falls on winter scenery and builds up and falls through holes that funnel it to the base where it is picked up to be cycled to the dome repeatedly until turned off.

### CROSS-REFERENCE TO RELATED APPLICATIONS

Not Applicable

### STATEMENT REGUARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention is a self-contained sealed unit. It receives power from a standard 110 v ac home outlet. “Snow” material is re-circulated with air within the unit making it maintenance free.

### BRIEF SUMMARY OF THE INVENTION

The Winter Dome uses air to softly blow “snow” up into a sealed dome. It then floats down slowly onto a winter scenery. The snow material builds up and falls through various holes in the base. The snow is then directed to a pick up area where the air flow can pick it up to be pumped back into the dome. The cycle repeats until the power is turned off.

### BRIEF DESCRIPTION OF THE SEVERAL VIEWS OF THE DRAWING

FIG. 1 shows the unit assembled with the various parts labeled. Arrows depict the flow of the snow material.

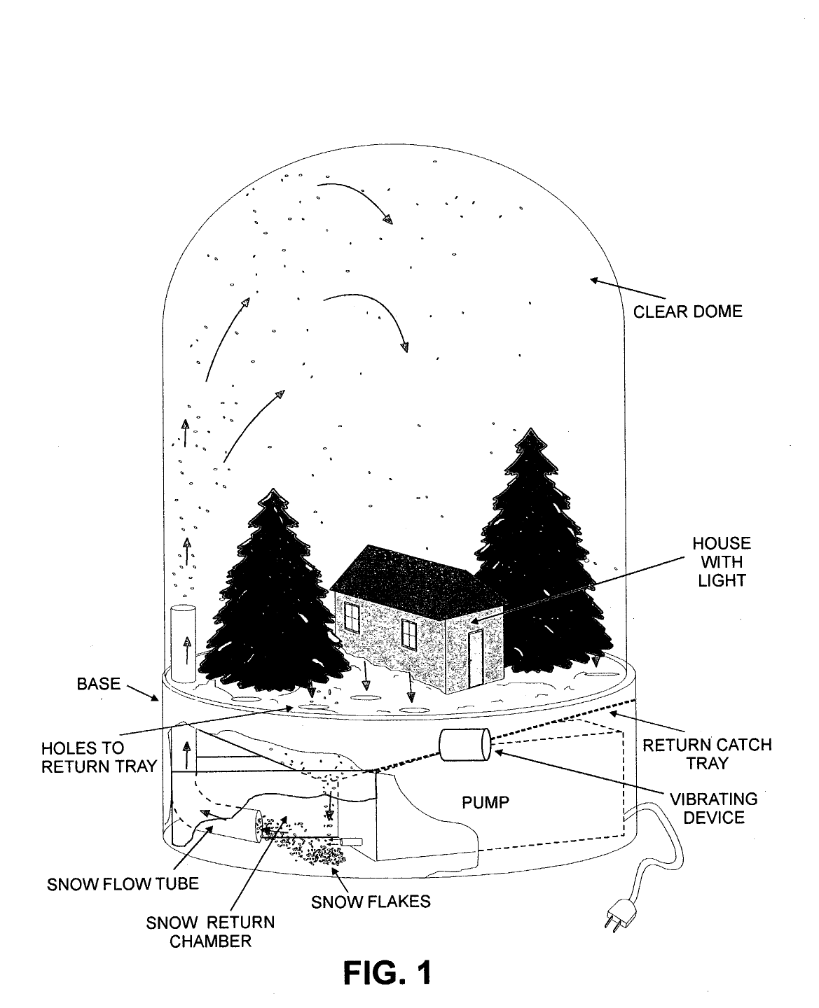

FIG. 2 is an exploded view of the unit with parts numbered and direction of assembly shown.

### DETAILED DESCRIPTION OF THE INVENTION

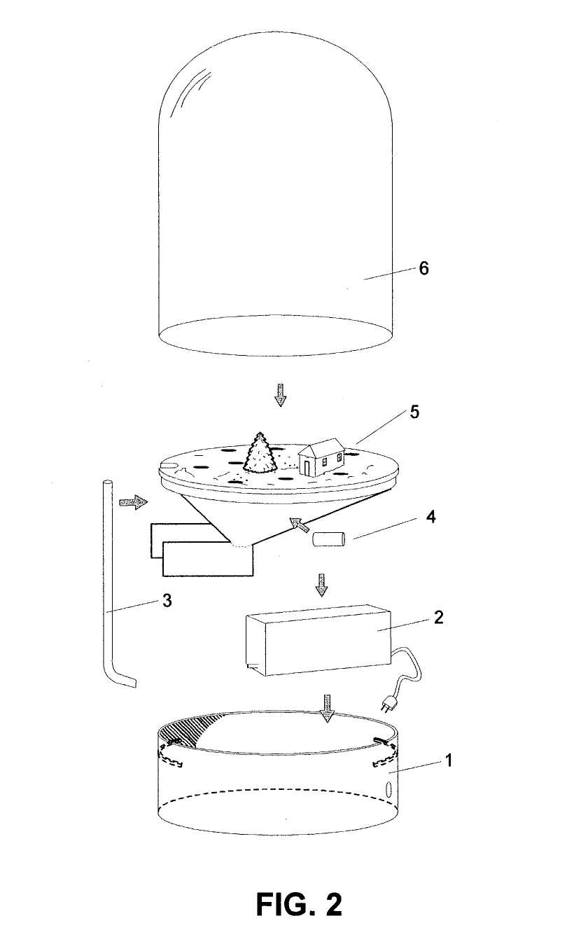

The Winter Dome is comprised of 6 (six) different parts. From the bottom up, the base (FIG. 2 #1) is cylindrical shaped with the top open. It is made of hard plastic and has a hole for Electric cord and support rings to hold the catch tray and scene. The air pump, (FIG. 2 #2) is an Apollo Model AM5 and is mounted to base with cord through hole. Transfer tube (FIG. 2 #3) is used to direct “snow” which is made of tiny, irregular shaped pieces of nonflammable and nontoxic foam material, and air up from base and into top of dome (FIG. 2 #6). The tube is made of 1¼″ plastic tubing with a 90° bend at the end. The air pump blows air which mixes with snow material at the end of the tube bend then flows up the tube into the dome. The “snow” then floats down onto the winter scenery (FIG. 2 #5) which is made of molded plastic and is painted to color and the bottom serves as the catch tray. As the snow builds it begins to fall through various holes in the scene base plate and is helped by a vibration device (FIG. 2 #4) into the catch tray (FIG. 2 #5) which is made of hard plastic and funneled shape to catch the material. The “snow” is directed down to the front of the pump and transfer tube. The air from the pump then starts the snow on another cycle that will repeat until the pump is turned off.

1. What I claim as my invention is a snowing dome that uses air to circulate the snow material.
